(19) United States
(12) Patent Application Publication
(10) Pub. No.: US 2026/0290149 A1
(43) Pub. Date: Sep. 24, 2026

(54) FIRE DETECTION SYSTEM DATA DEVICE

(71) Applicant: Tyco Fire & Security GmbH, Neuhausen am Rheinfall (CH)

(72) Inventors: Tobias EDMEADES, Munich (DE); Mazari BAHADURI, London (GB); Steven BENNETT, Middlesex (GB); Samuel WILKINS, Norristhorpe (GB); Abilash NAIR, Middlesex (GB)

(21) Appl. No.: 19/473,380

(22) PCT Filed: Apr. 3, 2024
(86) PCT No.: PCT/IB2024/053262

§ 371 Date: Oct. 7, 2025

(51) Int. Cl. G08B 29/12; G08B 17/00; G08B 29/14

(52) U.S. Cl. CPC G08B 29/123; G08B 29/145; G08B 17/00

(57) ABSTRACT

A data device can include a cable port to couple the data device with a communications cable of a fire detection system. The data device can include an input circuit to detect a signal transmitted via the communications cable. The input circuit can record a data point associated with the signal. The data device can include a memory to store the data point. The data device can include an output circuit to transmit the data point stored in the memory to an external device.

### CROSS-REFERENCE TO RELATED APPLICATION

This PCT Application claims the benefit and priority to U.S. Provisional Application No. 63/494,985, filed Apr. 7, 2023, the contents of which are incorporated herein by reference in its entirety.

### BACKGROUND

Fire detection systems can be used to detect fire events in facilities. Such systems can detect characteristics of a fire event (e.g., heat, smoke) and can output a signal indicative of the fire event.

### SUMMARY

At least one aspect relates to a data device. The data device can include a cable port to couple the data device with a communications cable of a fire detection system. The data device can include an input circuit to detect a signal transmitted via the communications cable. The input circuit can record a data point associated with the signal. The data device can include a memory to store the data point. The data device can include an output circuit to transmit the data point stored in the memory to an external device.

At least one aspect relates to a method. The method can include detecting, by a data device, a signal transmitted via a communications cable of the fire detection system. The data device can be communicably and electrically coupled with the communications cable. The method can include recording, by the data device, a data point associated with the signal. The method can include storing, by the data device, the data point. The method can include outputting, by the data device, the data point to an external device.

At least one aspect relates to a fire detection system. The fire detection system can include a fire panel. The fire detection system can include a device disposed remote from the fire panel. The fire detection system can include a communications cable coupling the fire panel with the device. The device to transmit a signal via the communications cable. The fire detection system can include a data device to couple with the communications cable. The data device can include an input circuit to detect a signal transmitted via the communications cable. The input circuit can record a data point associated with the signal. The data device can include a memory to store the data point. The data device can include an output circuit to transmit the data point stored in the memory to an external device.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a schematic diagram of an example fire detection system, in accordance with some aspects.

FIG. 2 depicts a schematic diagram of an example fire detection system, in accordance with some aspects.

FIG. 3 depicts a schematic diagram of an example data device, in accordance with some aspects.

FIG. 4 depicts a front, top perspective view of an example data device, in accordance with some aspects.

FIG. 5 depicts a front, open view of an example fire panel and data device, in accordance with some aspects.

FIG. 6 depicts a flow diagram illustrating an example method to monitor a fire detection system, in accordance with some aspects.

### DETAILED DESCRIPTION

Following below are more detailed descriptions of various concepts related to, and implementations of, methods, apparatuses, and systems of monitoring a fire detection system. The various concepts introduced above and discussed in greater detail below may be implemented in any of numerous ways.

The present disclosure is directed to systems and methods for monitoring a fire detection system. A fire detection system can be used as a first line of defense against fires in a building. The fire detection system can include a variety of devices, including but not limited to sensors, alarms, sprinklers, doors, and HVAC systems, to detect a fire and to respond to a fire. The devices can transmit signals along a communications cable (e.g., a loop). The signals can indicate a status of the building (e.g., normal state, fire state) or a status of the device (e.g., normal operation state, faulty operation state). The present disclosure is directed to a data device that can listen to the communications cable (e.g., monitor electrical characteristics of signals communicated along the communications cable) and can obtain the data indicated by the signal. For example, the data device can detect the signal, and can record or make a copy of any information being transmitted via the signal. The data device can store the information and transmit the information to an external component (e.g., an external computing device, remote server) at any time.

The disclosed solutions provide a system that can continuously monitor a status of a fire detection system and its components to assist in detecting operation errors regarding the devices of the fire detection system. The disclosed solution provides a system that can be located at any location along the communications cable of the fire detection system to facilitate accessibility and a system that requires no external power source besides the power provided by the communications cable. The disclosed solution can listen to the loop of the fire detection system and record communications between a fire panel and the various devices disposed along the loop.

The disclosed solutions can include a data device. The data device can couple with a communications cable of a fire detection system. The data device can be disposed within a fire panel of the fire detection system or external to the fire panel at any location along the communications cable. The data device can include an input circuit can detect signals transmitted via the communications cable. The input circuit can record or copy the data that is being transmitted via the signals. The data device can include a memory to store the data. The data device can store data associated with a plurality of devices that are a part of the fire detection system and coupled with the communications cable. The data device can include an output circuit to transmit the data to various external computing systems (e.g., external computer, remote server) via various methods (e.g., wired or wirelessly). The data device can operate based on power from the communications cable to allow for a more compact form factor and/or overcome restrictions on where the data device can be positioned (e.g., allow for the data device to be positioned in remote locations).

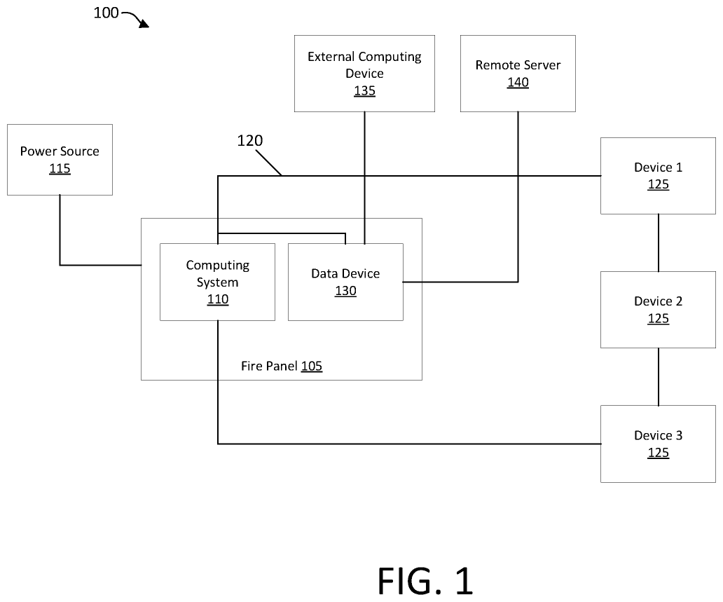

FIG. 1 depicts a schematic diagram of an example fire detection system 100. The fire detection system 100 can be used to protect a building and its occupants from possible fire events. For example, the fire detection system 100 can monitor a building (e.g., office building, warehouse, school, hospital, etc.) to identify an occurrence of an event (e.g., a fire). The fire detection system 100 can include at least one fire panel 105. The fire panel 105 can receive signals from and transmit signals to various devices or systems that are a part of the fire detection system 100. The fire panel 105 can monitor a status of such devices or systems and can generate commands to control such devices or systems. The fire panel 105 can include at least one computing system 110. The computing system 110 can detect, receive, store, interpret, or transmit signals that are transmitted across the fire detection system 100. The signals can include or be associated with data or data points. For example, the signals can indicate when a fire is present, when a glass barrier is broken, when a sprinkler is actuated, among others. The fire panel 105 can include one or more wired and/or wireless interfaces for communication with remote components. The fire panel 105 can communicate indications of fire events to one or more remote components, and can include a user interface for receiving inputs and presenting outputs.

The fire panel 105 can be coupled with a power source 115. The fire panel 105 can receive power from the power source 115 to operate. For example, the computing system 110 can operate on power from the power source 115.

The fire detection system 100 can include at least one communications cable 120. The communications cable 120 can provide a path for signals to travel between devices and systems that are a part of the fire detection system 100. The communications cable 120 can define a loop such that signals can travel to and from various systems and devices that are disposed along the communications cable 120. The communications cable 120 can be coupled with the fire panel 105. For example, the fire panel 105 can receive signals or transmit signals via the communications cable 120. The communications cable 120 can receive power from the power source 115 via the fire panel 105. The communications cable 120 can provide power to various systems and devices that are coupled with and disposed along the communications cable 120.

The fire detection system can include at least one device 125. The device 125 can be any device that can facilitate monitoring of a zone or suppressing a fire in a zone. For example, the device 125 can be a fire detection device (e.g., a sensor or detector) to detect an occurrence of a fire or alert a person of the fire. For example, the device 125 can be a smoke detector, a heat detector, a fire detector, a sprinkler sensor, a hose reel sensor, a pull-down sensor, a break glass sensor, a bell/siren, a beacon, or a module that controls a fire door or other safety features, among others. The device 125 can be fire suppression device to, for example, extinguish or contain a fire. For example, the device 125 can be a door, a shutter, or a HVAC system, among others.

The device 125 can be disposed external to and remote from the fire panel 105. The communications cable 120 can extend between the fire panel 105 and the device 125. For example, the communications cable 120 can couple the fire panel 105 with the device 125. The device 125 can transmit a signal via the communications cable 120. For example, the device 125 can transmit a signal to the fire panel 105 via the communications cable 120. The signal can indicate a status of the device 125 or a status of a zone that the device 125 is monitoring. The signal can include at least one data point associated with the device 125 or the zone of the building. A recipient of the signal can decipher or read the data point from the signal. The fire panel 105 can transmit a signal via the communications cable 120. For example, the fire panel 105 can transmit a signal to a device 125. The signal can indicate a command to actuate the device 125 (e.g., close a door, turn on an HVAC system, activate a sprinkler, sound an alarm, etc.).

The fire detection system 100 can include a plurality of devices 125. For example, a plurality of devices 125 can be coupled with the communications cable 120. The devices 125 can be disposed at various locations along the communications cable 120. The devices 125 can be connected to each other in series or in parallel. The plurality of devices 125 can generate a plurality of data points associated with the devices 125 or the zone(s) that the devices 125 is/are associated with. For example, the data points can indicate a functionality or health of the device 125 (e.g., low battery, faulty operation) or an occurrence of an event in a zone (e.g., a fire, a lever has been pulled, glass has been broken).

The fire detection system 100 can include at least one data device 130. The data device 130 can detect, receive, or intercept signals that are transmitted along the communications cable 120 of the fire detection system 100 to monitor the fire detection system 100. Monitoring the fire detection system 100 can include monitoring a status of the devices 125 of the fire detection system 100 (e.g., functioning properly or improperly) or monitoring a state of a zone (e.g., normal state or emergency state (e.g., fire)). The data device 130 can store data (e.g., data points) associated with or corresponding to the signals. For example, the data device 130 can detect a signal transmitted along the communications cable 120 (e.g., detect at least one of a voltage or a current of the signal at one or more points in time). Responsive to detection, the data device 130 record or make a copy of a data point indicated by the signal. The data device 130 can couple with the communications cable 120. The data device 130 can be coupled with the communications cable 120 at any location along the communications cable 120. For example, the data device 130 can be disposed in the fire panel 105. The data device 130 can be coupled with a portion of the communications cable 120 that is disposed in the fire panel 105. The data device 130 can be disposed external to the fire panel 105. The data device 130 can be coupled with a portion of the communications cable 120 that is disposed external to the fire panel 105.

The data device 130 can receive operating power from the communications cable 120. For example, the data device 130 can operate based on the power from the communications cable 120. The data device 130 can operate based on the power from the power source 115.

The fire detection system 100 can include at least one external computing device 135. The external computing device 135 can be coupled with the data device 130. The external computing device 135 can be coupled with the data device 130 via a wired or wireless connection. The external computing device 135 can be selectively coupled with the data device 130 to retrieve or receive data from the data device 130. The external computing device 135 can obtain the data stored on the data device 130 at any time.

The fire detection system 100 can include at least one remote server 140. The remote server 140 can be a cloud-based platform. The remote server 140 can be coupled with the data device 130. The remote server 140 can be coupled with the data device 130 via a wired or wireless connection. The remote server 140 can be selectively coupled with the data device 130 to retrieve or receive data from the data device 130. The external computing device 135 can obtain the data stored on the data device 130 at any time.

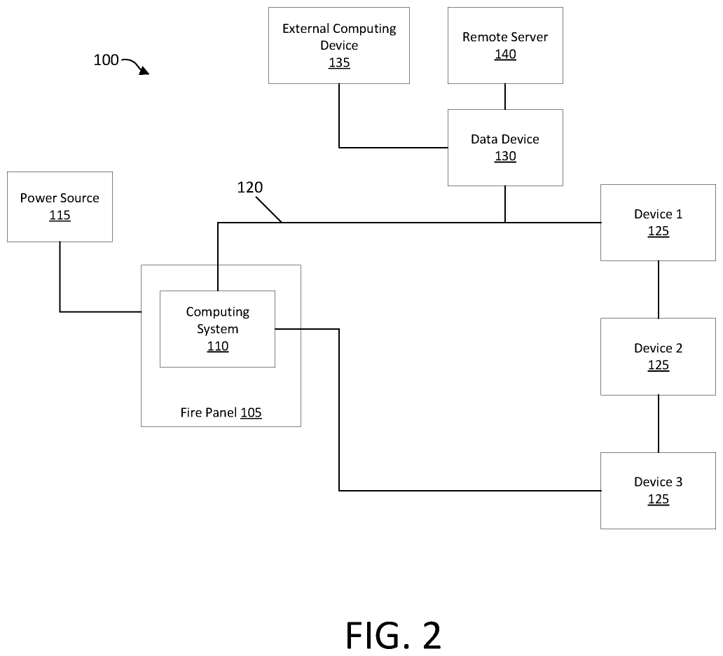

FIG. 2 depicts a schematic diagram of an example fire detection system 100. The data device 130 can be coupled with the communications cable 120 at any location along the communications cable 120. For example, the data device 130 can be disposed external to the fire panel 105. The data device 130 can be coupled with a portion of the communications cable 120 that is disposed external to the fire panel 105. The data device 130 can be powered by the power from the power source 115 via the communications cable 120.

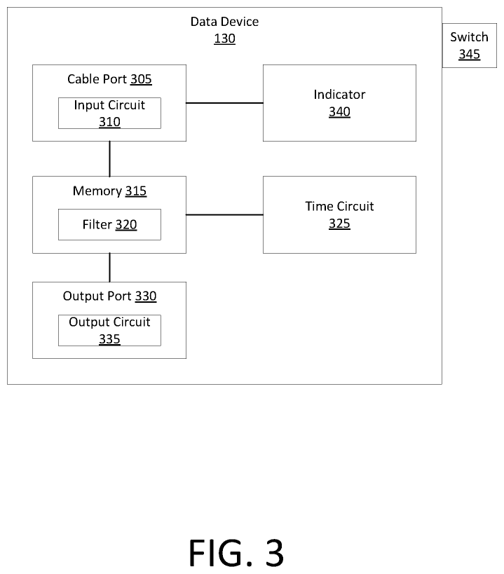

FIG. 3 depicts a schematic diagram of the data device 130. The data device 130 can include at least one cable port 305. The cable port 305 can couple the data device 130 with at least one communications cable 120. For example, the cable port 305 can receive a portion of the communications cable 120. The data device 130 can detect, receive, or intercept the signals transmitted via the communications cable 120 via the cable port 305. For example, the cable port 305 can include or be coupled with at least one input circuit 310. The input circuit 310 can detect a signal transmitted via the communications cable 120. The input circuit 310 can obtain at least one data point from the signal. For example, the signal can include or indicate a data point. The data point can be associated with, for example, a status of a device 125 that transmitted the signal or an occurrence (or lack thereof) of a fire in a zone associated with the device 125 that transmitted the signal. The input circuit 310 can receive, intercept, record, or make a copy of the data point. For example, the input circuit 310 can record any information or data being transmitted via the signal, and allow the signal to continue its path to the initial intended recipient (e.g., the fire panel 105).

The data device 130 can receive operating power via the cable port 305. For example, the data device 130 can operate on the power traveling through the communications cable 120 from the power source 115. This can allow the data device 130 to be disposed at various locations relative to the fire detection system 100.

The data device 130 can include at least one memory 315. The memory 315 (e.g., memory, memory unit, storage device) can include one or more devices (e.g., RAM, ROM, EPROM, EEPROM, optical disk storage, magnetic disk storage or other magnetic storage devices, flash memory (e.g., SD chip), hard disk storage, or any other medium) for storing data and/or computer code for completing or facilitating the various processes, layers, and circuits described in the present disclosure. The memory 315 can be or include transitory memory or non-transitory memory, and can include database components, object code components, script components, or any other type of information structure for supporting the various activities and information structures described in the present disclosure. The memory 315 can be communicably coupled with any of the components within the data device 130. The memory 315 can include computer code for executing the processes described herein.

The memory 315 can store at least one data point associated with a signal transmitted via the communications cable 120. The data point can be raw data or processed data. The data point can be associated with a signal or the device 125 that transmitted the signal. The memory 315 can store a plurality of data points. The plurality of data points can be associated with a plurality of signals. The plurality of signals can be transmitted by a single device 125 or a plurality of devices 125.

The memory 315 can include a filter 320. The filter 320 can filter, organize, combine, or otherwise sort a plurality of data points. For example, the filter 320 can organize the data points based on a data point characteristic of each data point. A data point characteristic can be, for example, origin (e.g., associated device 125 that generated the signal associated with the data point), time (e.g., when the data point was received, recorded, or copied), or content (e.g., indicating faulty device 125, indicating fire, indicating normal operation), among others. Filtering the plurality of data points can, for example, facilitate detection of a faulty device 125 coupled with the communications cable 120.

The data device 130 can include at least one time circuit 325. The time circuit 325 can apply at least one of a date or time to a data point stored in the memory 315 (e.g., apply a time stamp). The time and date can be based on when the signal that represents the data point is transmitted via the communications cable or when the data device 130 receives the signal. The filter 320 can use the time applied by the time circuit to sort or filter the data points.

The data device 130 can include at least one output port 330. The output port 330 can be or include at least one of a wired or wireless connection to transfer the data points in the memory 315 to the external computing device 135 or remote server 140. For example, the output port 330 can be a physical, wired port to receive a cable coupled with the external computing device 135. The output port 330 can be any type of physical port, including but not limited to a USB, HDMI, UART, or Ethernet port. The output port 330 can be a wireless port to wirelessly connect with an external computing device 135 or remote server 140. For example, the output port 330 can be a Bluetooth®, Wi-Fi®, of Near Field Communication (NFC) port.

The data device 130 can include at least one output circuit 335. The output port 330 can include or be coupled with the output circuit 335. The output circuit 335 can facilitate transmission of the data stored in the memory 315 to a recipient (e.g., external computing device 135, remote server 140). For example, the output circuit 335 can output or transmit the data (e.g., data points) to the external computing device 135 or the remote server 140 via the output port 330. The external computing device 135 or remote server 140 can retrieve or receive the data via the output circuit 335.

The data device 130 can include a plurality of output ports 330. For example, the data device 130 can include a combination of wire and wireless ports. For example, the data device 130 can have a first output port 330 and a second output port 330. The first output port 330 can be a wired port (e.g., UART). The second output port 330 can be a wireless port (e.g., Bluetooth®).

The data device 130 can include no power supply port. For example, the data device 130 cannot provide power to other devices. For example, the data device 130 cannot provide power to the external computing device 135.

The data device 130 can include at least one indicator 340. The indicator 340 can provide a visual or audio indication to a user. For example, the indicator 340 can be a light (e.g., an LED) or a speaker. Actuation of the indicator 340 can indicate a state or action of the data device 130. For example, the indicator 340 can activate when the data device 130 is powered on and deactivate when the data device 130 is powered off. The indicator 340 can activate when the data device 130 detects, receives, or intercepts a signal transmitted along the communications cable 120. The indicator 340 can activate when the data device 130 records or copies a data point with a predetermined data point characteristic.

The data device 130 can include at least one switch 345. The switch 345 can selectively activate (and deactivate) the data device 130, or a component thereof. The switch 345 can activate the data device 130 responsive to a user input. The switch 345 can be a physical switch to receive a physical input. The switch 345 can be a non-physical (e.g., electrical, etc.) switch to receive a non-physical input (e.g., a signal).

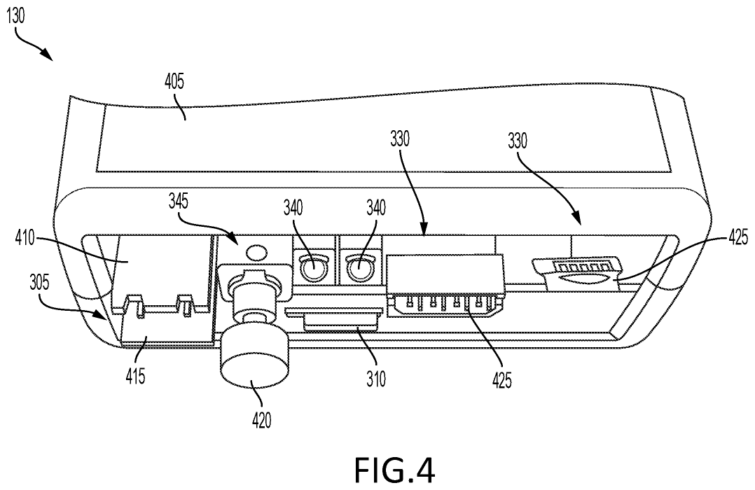

FIG. 4 depicts an example data device 130. The data device 130 can include a housing 405. The housing 405 can be a protective barrier for other components of the data device 130. The housing 405 can define a cavity 410. The other components of the data device 130 can be disposed, at least partially, in the cavity.

The data device 130 can include a cable port 305. The cable port 305 can have a cable port interface 415. The cable port interface 415 can be accessible from an exterior of the data device 130. For example, the cable port interface 415 can be exposed (e.g., not confined by the housing 405).

The data device 130 can include a switch 345. The switch 345 can be a physical switch (e.g., a button) to be actuated by a physical force. The switch 345 can have a switch interface 420. The switch 345 can be accessible from an exterior of the data device 130. For example, the switch interface 420 can be exposed (e.g., not confined by the housing 405).

The data device 130 can include an indicator 340. The indicator 340 can be a LED. At least a portion of the indicator 340 can be visible from an exterior of the data device 130. For example, the indicator 340 can be at least partially exposed (e.g., not confined by the housing 405). The data device 130 can include a plurality of indicators 340. The plurality of indicators 340 can include any combination of indicators 340.

The data device 130 can include at output port 330. The output port 330 can be a wired output port 330 (e.g., UART, USB). The output port 330 can have an outlet port interface 425. The output port 330 can be accessible from an exterior of the data device 130. For example, the outlet port interface 425 can be exposed (e.g., not confined by the housing 405). The data device 130 can include a plurality of output ports 330. For example, the data device 130 can include a first output port 330 (e.g., UART) and a second output port 330 (e.g., USB). The output port 330 can be a wireless output port 330 (e.g., Bluetooth®).

The data device 130 can include a memory 315. The memory 315 can be or include, for example, an SD card. The SD card can removable from the data device 130.

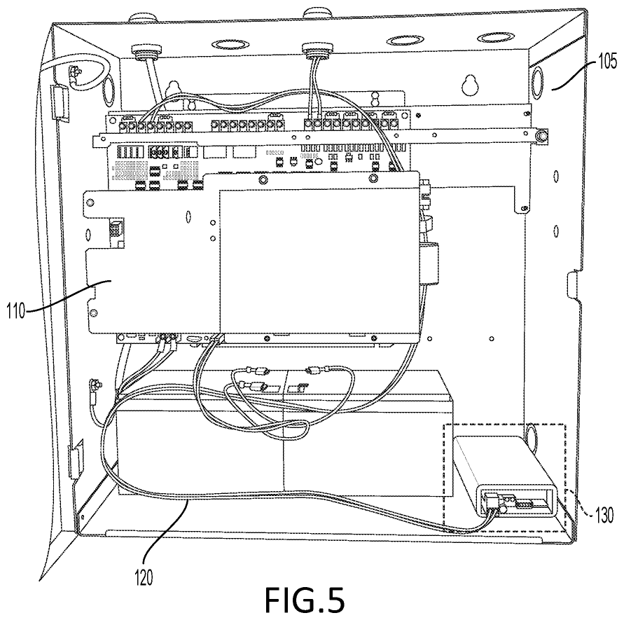

FIG. 5 depicts an example fire panel 105 and a data device 130. The data device 130 can be disposed in the fire panel 105. The data device 130 can be coupled with the computing system 110 of the fire panel 105 via the communications cable 120. The data device 130 can be coupled with a portion of the communications cable 120 that is disposed in the fire panel 105.

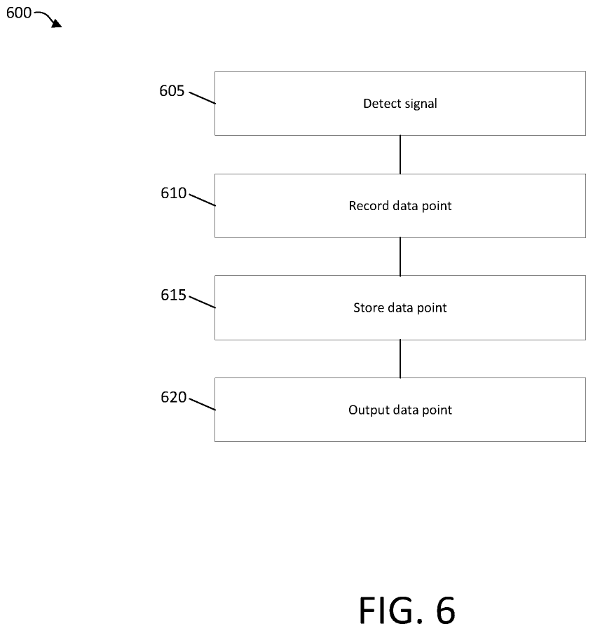

FIG. 6 depicts a block diagram of a method 600 for monitoring a fire detection system 100. Method 600 can include detecting a signal (Act 605). At act 605, a data device 130 can detect a signal transmitted via a communications cable 120 of the fire detection system 100. For example, a device 125 can transmit a signal along the communications cable 120 to the fire panel 105. The data device 130 can be electrically coupled with the communications cable 120. The data device 130 can receive operating power from the communications cable 120. The data device 130 can detect the signal. The data device 130 can detect a plurality of signals. For example, a single device 125 can transmit a plurality of signals or a plurality of devices 125 can transmit a plurality of signals.

Method 600 can include recording or copying a data point (Act 610). At act 610, the data device 130 can record a data point associated with the detected signal. For example, the signal can indicate data or a data point. The data device 130 can record the data point associated with the signal and the signal can continue to the intended recipient (e.g., the fire panel 105). The data device 130 can record a plurality of data points associated with a plurality of signals.

Method 600 can include storing a data point (Act 615). At act 615, the data device 130 can store the data point. The data device 130 can include a memory 315. The data device 130 can store the data point in the memory 315. The data device 130 can store a plurality of data points (e.g., data) in the memory 315. Act 615 can include applying a time stamp to a data point. For example, the data device 130 can associated a data point with a specific time. The time stamp can be based on or indicate when the signal is transmitted via the communications cable 120 or when the signal is detected by the data device 130. The data device 130 can store a plurality of data points. The data device 130 can apply a time stamp to the plurality of data points, or a subset thereof.

Act 615 can include the data device 130 filtering a plurality of data points. For example, the data device 130 can include a filter 320. The filter 320 can filter, organize, combine, or otherwise sort a plurality of data points. For example, the filter 320 can organize the data points based on a data point characteristic of each data point. A data point characteristic can be, for example, origin (e.g., associated device 125 that generated the signal associated with the data point), time (e.g., when the data point was received, recorded, or copied), or content (e.g., indicating faulty device 125, indicating fire, indicating normal operation), among others. Filtering the plurality of data points can, for example, facilitate detection of a faulty device 125 coupled with the communications cable 120.

Method 600 can include outputting a data point (Act 620). At act 620, the data device 130 can output the data point to an external device (e.g., an external computing device 135, a remote server 140). For example, act 620 can include communicably coupling the data device 130 with an external device via at least one of a wired or wireless connection to transmit the data point to the external device. The wired connection can be, for example, via a UART cable connection via an output port 330 of the data device 130. The wireless connection can be, for example, Bluetooth® connection via an output port 330 of the data device 130. The data device 130 can output the data point at any time. The data device 130 can output a plurality if data points.

Some of the description herein emphasizes the structural independence of the aspects of the system components or groupings of operations and responsibilities of these system components. Other groupings that execute similar overall operations are within the scope of the present application. Modules and circuits can be implemented in hardware or as computer instructions on a non-transient computer readable storage medium, and modules and circuits can be distributed across various hardware or computer based components, e.g., as part of data device 130.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “device”, “circuit”, “component”, “controller” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. The data device 130 can include any of these elements.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of top and bottom components may be reversed. Elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, communicably, operably, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A data device, comprising:
a cable port to couple the data device with a communications cable of a fire detection system;
an input circuit to detect a signal transmitted via the communications cable, the input circuit to record a data point associated with the signal;
a memory to store the data point; and
an output circuit to transmit the data point stored in the memory to an external device.

2. The data device of claim 1, comprising:
a time circuit to apply at least one of a date or a time to the data point stored in the memory, the at least one of the date and time based on when the data device receives the signal via the communications cable.

3. The data device of claim 1, comprising:
the data point stored by the memory comprises raw data associated with the signal, the signal transmitted by a device coupled with the communications cable, the device comprising at least one of a smoke detector, a heat detector, a fire detector, a sprinkler sensor, a hose reel sensor, a pull-down sensor, a break glass sensor, or a module that controls a fire door.

4. The data device of claim 1, comprising:
the data device is to receive operating power from the communications cable.

5. The data device of claim 1, comprising:
an output port comprising at least one of a wired or wireless connection to transfer the data point to the external device.

6. The data device of claim 1, comprising:
the data device to be disposed in a fire panel of the fire detection system.

7. The data device of claim 1, comprising:
the data device to be coupled with the communications cable at any location along the communications cable.

8. The data device of claim 1, comprising:
the memory to store a plurality of data points, including the data point, the plurality of data points associated with a plurality of signals, including the signal; and
a filter to filter the plurality of data points to facilitate detection of a faulty device coupled with the communications cable.

9. The data device of claim 1, comprising:
no power supply port to provide power to the external device.

10. A method of monitoring a fire detection system, comprising:
detecting, by a data device, a signal transmitted via a communications cable of the fire detection system, the data device communicably and electrically coupled with the communications cable;
recording, by the data device, a data point associated with the signal;
storing, by the data device, the data point; and
outputting, by the data device, the data point to an external device.

11. The method of claim 10, comprising:
applying, by the data device, a time stamp to the data point based on when the data device detects the signal via the communications cable.

12. The method of claim 10, comprising:
recording, by the data device, a plurality of data points, including the data point, the plurality of data points associated with a plurality of signals, including the signal; and
filtering the plurality of data points to facilitate detection of a faulty device coupled with the communications cable.

13. The method of claim 10, comprising:
communicably coupling the data device with the external device via at least one of a wired or wireless connection to transmit the data point to the external device.

14. The method of claim 10, comprising:
receiving, by the data device, operating power from the communications cable.

15. The method of claim 10, comprising:
coupling the data device to a portion of the communications cable, the portion of the communications cable disposed in a fire panel.

16. A fire detection system, comprising:
a fire panel;
a device disposed remote from the fire panel;
a communications cable coupling the fire panel with the device, the device to transmit a signal via the communications cable; and
a data device to couple with the communications cable, the data device comprising:
an input circuit to detect the signal transmitted via the communications cable, the input circuit to record a data point associated with the signal;
a memory to store the data point; and
an output circuit to transmit the data point stored in the memory to an external device.

17. The fire detection system of claim 16, comprising:
a plurality of devices including the device, the plurality of devices coupled with the communications cable; and
the memory of the data device to store a plurality of data points generated by the plurality of devices.

18. The fire detection system of claim 16, comprising:
the data device comprising a time circuit to apply at least one of a date or a time to the data point stored in the memory, the at least one of the date or the time based on when the signal is transmitted via the communications cable.

19. The fire detection system of claim 16, comprising:
the communications cable to receive power from a fire panel power source; and
the data device to receive the power from the communications cable, the data device to operate based on the power from the communications cable.

20. The fire detection system of claim 16, comprising:
the data device disposed in the fire panel.
